(19) United States
(12) Patent Application Publication
(10) Pub. No.: US 2025/0291390 A1
(43) Pub. Date: Sep. 18, 2025

(54) DISPLAY MODULE

(71) Applicant: SAMSUNG DISPLAY CO., LTD., YONGIN-SI (KR)

(72) Inventors: MUNSIK HAM, Yongin-si (KR); HOSUNG NAM, Yongin-si (KR); HOSEUNG KANG, Yongin-si (KR); Hyunsu SIM, Yongin-si (KR)

(21) Appl. No.: 19/004,827

(22) Filed: Dec. 30, 2024

(30) Foreign Application Priority Data
Mar. 18, 2024 (KR) 10-2024-0037059

(51) Int. Cl. G06F 1/16

(52) U.S. Cl. CPC G06F 1/1656; G06F 1/1616

(57) ABSTRACT

A display module includes a display unit including a foldable area and a non-folding area adjacent thereto. A cover member is disposed on a rear surface of the display unit and includes a cover portion covering a portion of the display unit overlapping each of the foldable and non-folding areas. The cover portion has at least one opening defined therein which exposes at least a portion of a side surface of the display unit. A first holding portion extends from the cover portion in a first direction and protrudes to an outside of the display unit. A second holding portion extends from the cover portion in a second direction and protrudes to the outside of the display unit. A third holding portion is spaced apart from the second holding portion in the second direction and protrudes to the outside of the display unit.

### CROSS-REFERENCE TO RELATED APPLICATION(S)

This application claims priority under 35 U.S.C. § 119 to Korean Patent Application No. 10-2024-0037059, filed on Mar. 18, 2024 in the Korean Intellectual Property Office, the disclosure of which is incorporated by reference in its entirety herein.

### 1. TECHNICAL FIELD

Embodiments of the present disclosure relate to a display module. More particularly, embodiments of the present disclosure relate to a display module for inspection.

### 2. DISCUSSION OF RELATED ART

A display device provides information to a user by displaying various images on a screen. Generally, the display device displays information within an allocated display portion of the display device. Recently, a variety of bendable and flexible display devices have been developed. In contrast to flat panel displays, bendable and flexible display devices may be folded, rolled, bent or otherwise deformed similar to paper. The flexible display devices having deformable shapes may be provided regardless of the existing size of the display area, so that convenience of user is increased.

Recently, research has been conducted on methods for inspecting defects in the flexible display devices. In particular, research is being conducted on a cover member that may inspect the display device for defects to prevent damage to the display device.

### SUMMARY

Embodiments provide a display module with increased inspection efficiency.

According to an embodiment of the present disclosure, a display module includes a display unit including a foldable area and a non-folding area adjacent to the foldable area. A cover member is disposed on a rear surface of the display unit. The cover member includes a cover portion covering a portion of the display unit overlapping each of the foldable area and the non-folding area. The cover portion has at least one opening defined therein. The at least one opening exposes at least a portion of a side surface of the display unit. A first holding portion extends from the cover portion in a first direction. The first holding portion protrudes to an outside of the display unit in a plan view. A second holding portion extends from the cover portion in a second direction that intersects with the first direction. The second holding portion protrudes to the outside of the display unit in the plan view. A third holding portion is spaced apart from the second holding portion in the second direction. The third holding portion protrudes to the outside of the display unit in the plan view.

In an embodiment, the non-folding area may include a first non-folding area adjacent to a first side of the foldable area and a second non-folding area adjacent to a second side of the foldable area opposite to the first side. The second non-folding area is spaced apart from the first non-folding area in the first direction. The cover portion may include a first cover portion covering a portion of the display unit overlapping each of the first non-folding area, the second non-folding area, and foldable area and a second cover portion covering a portion of the display unit overlapping the second non-folding area.

In an embodiment, the first cover portion may include a first body portion connected to the second cover portion, a first arm portion extending from the first body portion in the first direction, a second arm portion extending from the first body portion in the second direction, a third arm portion extending from the first body portion in a direction opposite to the second direction, a first connection portion connecting the first holding portion and first arm portion to each other, a second connection portion connecting the second holding portion and the second arm portion to each other, and a third connection portion connecting the third holding portion and the third arm portion to each other.

In an embodiment, the at least one opening may include a first opening and a second opening. The first opening may be defined in the second connection portion. The first opening exposing a portion of a first side surface of the display unit overlapping the foldable area. The second opening is defined in the third connection portion. The second opening exposes a portion of a second surface opposite to the first side surface of the display unit overlapping the foldable area.

In an embodiment, the first connection portion may include a first base portion integrated with the first arm portion and the first holding portion. The first base portion extending from an end of the first arm portion to a height co-planar with an upper surface of the first holding portion. A first protrusion protrudes from an upper surface of the first base portion in a normal direction of the upper surface of the first holding portion.

In an embodiment, the second connection portion may include a second base portion integrated with the second arm portion and the second holding portion. The second base portion extending from an end of the second arm portion to a height co-planar with an upper surface of the second holding portion. A second protrusion protrudes from an upper surface of the second base portion in a normal direction of the upper surface of the second holding portion. In an embodiment, the third connection portion may include a third base portion integrated with the third arm portion and the third holding portion. The third base portion extends from an end of the third arm portion to a height co-planar with an upper surface of the third holding portion. A third protrusion protrudes from an upper surface of the third base portion in a normal direction of the upper surface of the third holding portion.

In an embodiment, the cover member may include a fourth holding portion spaced apart from the first body portion in a direction opposite to the first direction. The fourth holding portion protrudes to the outside of the display unit in the plan view. The second cover portion may include a second body portion connected to the first body portion, and a fourth connection portion connecting the fourth holding portion and the second body portion to each other.

In an embodiment, the fourth connection portion may include a fourth base portion integrated with the second body portion and the fourth holding portion. The fourth base portion extends from an end of the second body portion to a height co-planar with an upper surface of the fourth holding portion. A fourth protrusion protruding from an upper surface of the fourth base portion in a normal direction of the upper surface of the fourth holding portion.

In an embodiment, a guide hole is defined in the fourth holding portion. The guide hole penetrates the fourth holding portion in a thickness direction of the fourth holding portion. An area of the fourth holding portion in the plan view is greater than an area of each of the first, second, and third holding portion in the plan view.

In an embodiment, the display module may further include a release film disposed between the display unit and the cover member and an adhesive layer disposed between the release film and the cover member.

In an embodiment, the display unit may include a display panel including at least one pixel, a driver disposed on the display panel, and a driver cover member covering the driver.

In an embodiment, a third opening is defined in the second cover portion. The third opening exposes a portion of an upper surface of the driver cover member. The third opening may not overlap the release film in a plan view.

In an embodiment, at least one third opening is defined in the first cover member. The at least one third opening exposes a portion of the rear surface of the display unit.

In an embodiment, the at least one opening may expose a portion of the release film directly contacting the rear surface of the display unit overlapping the foldable area.

In an embodiment, the second non-folding area may include a bending area that is bendable along a bending axis extending parallel to the second direction, and the second cover portion may cover a portion of the display unit overlapping the bending area.

According to an embodiment of the present disclosure, a display module includes a display unit including a foldable area and a non-folding area adjacent to the foldable area. A cover member is disposed on a rear surface of the display unit. The cover member includes a body portion covering a portion of the display unit overlapping the foldable area and the non-folding area. An arm portion extends from the body portion in a first direction or a second direction that intersects with the first direction. At least one holding portion is spaced apart from the arm portion. The at least one holding portion protrudes to an outside of the display unit in a plan view. A base portion is integrated with the arm portion and the holding portion. The base portion extends from a portion adjacent to the arm portion to a height co-planar with an upper surface of the at least one holding portion. A protrusion is integrated with the base portion. The protrusion protrudes from the base portion in a normal direction of the upper surface of the at least one holding portion.

In an embodiment, at least one opening is defined in the base portion. The at least one opening exposes a portion of a side surface of the display unit overlapping the foldable area.

In an embodiment, a release film is disposed between the display unit and the cover member and an adhesive layer disposed between the release film and the cover member, and the at least one opening exposes a portion of the release film directly contacting the rear surface of the displayer unit overlapping the foldable area.

In an embodiment, an opening is defined in the body portion. The opening exposes at least a portion of the rear surface of the display unit.

In a display module according to embodiments of the present disclosure, the display module may include a cover member, which includes an arm portion overlapping a foldable area of the display unit, a holding portion protruding to an outside of the display unit, and a connection portion connecting the arm portion and the holding portion to each other. In the connection portion, an opening, which exposes a portion of each of a side surface and a rear surface of a lattice portion of the display unit is defined. Accordingly, an inspection efficiency of the lattice portion of the display module may be increased.

In addition, the connection portion may include a protrusion protruding in a normal direction of an upper surface of the holding portion. Accordingly, defects generated in the display module, during inspection process of the display module, may decrease, and an impact resistance of the display module may be increased.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating a display module according to an embodiment of the present disclosure.

FIG. 2 is a perspective view illustrating the display module of FIG. 1 in an upside-down state according to an embodiment of the present disclosure.

FIG. 3 is a exploded perspective view illustrating the display module of FIG. 1 that is in a disassembled state according to an embodiment of the present disclosure.

FIG. 4 is a cross-sectional view illustrating a cross-section of the display unit of FIG. 1 in an unfolded state according to an embodiment of the present disclosure.

FIG. 5 is a cross-sectional view illustrating a cross-section of the display unit of FIG in a bent state around a bending area according to an embodiment of the present disclosure.

FIG. 6 is a perspective view illustrating the cover member of FIG. 1 according to an embodiment of the present disclosure.

FIG. 7 is a perspective view illustrating the cover member of FIG. 1 in an upside-down state according to an embodiment of the present disclosure.

FIG. 8 is a plan view illustrating the display module of FIG. 1 according to an embodiment of the present disclosure.

FIG. 9 is a bottom view illustrating the display module of FIG. 1 according to an embodiment of the present disclosure.

FIG. 10 is a cross-sectional view illustrating a cross-section taken along a line A1-B1 of FIG. 8 according to an embodiment of the present disclosure.

FIG. 11 is a cross-sectional view illustrating a cross-section taken along a line A2-B2 of FIG. 8 according to an embodiment of the present disclosure.

FIG. 12 is a cross-sectional view illustrating a cross-section taken along a line A3-B3 of FIG. 8 according to an embodiment of the present disclosure.

FIG. 13 is a cross-sectional view illustrating a cross-section taken along a line A4-B4 of FIG. 8 according to an embodiment of the present disclosure.

FIG. 14 is a cross-sectional view illustrating a cross-section taken along a line C-D of FIG. 8 according to an embodiment of the present disclosure.

FIGS. 15 and 16 are views illustrating a method of manufacturing the display module of FIG. 1 according to embodiments of the present disclosure.

FIG. 17 is a bottom view illustrating a display module according to an embodiment of the present disclosure.

FIG. 18 is a bottom view illustrating a display module according to an embodiment of the present disclosure.

FIG. 19 is a perspective view illustrating a display device manufactured using the display module of FIG. 1 according to an embodiment of the present disclosure.

FIG. 20 is a perspective view illustrating the display device of FIG. 19 in a folded state according to an embodiment of the present disclosure.

FIG. 21 is a exploded perspective view illustrating the display device of FIG. 19 that is in a disassembled state according to an embodiment of the present disclosure.

### DETAILED DESCRIPTION OF EMBODIMENTS

Hereinafter, display modules in accordance with non-limiting embodiments of the present disclosure will be described in more detail with reference to the accompanying drawings. The same reference numerals are used for the same components in the drawings, and redundant descriptions of the same components will be omitted.

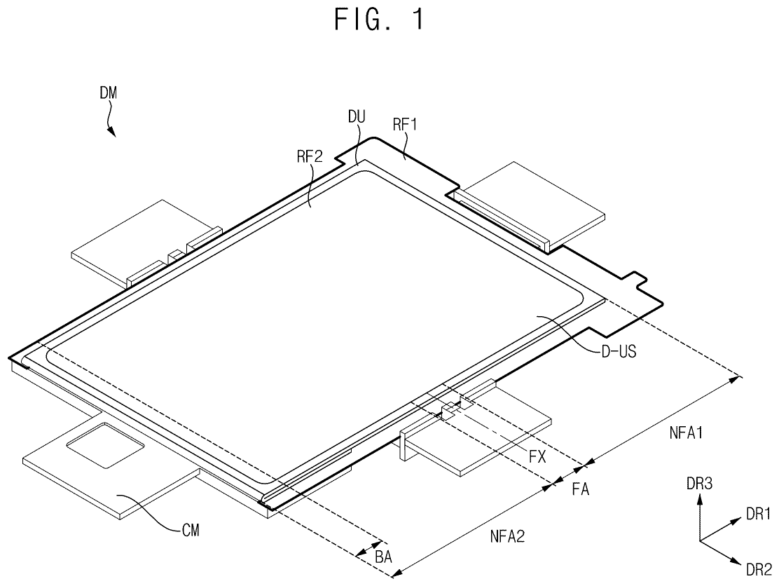

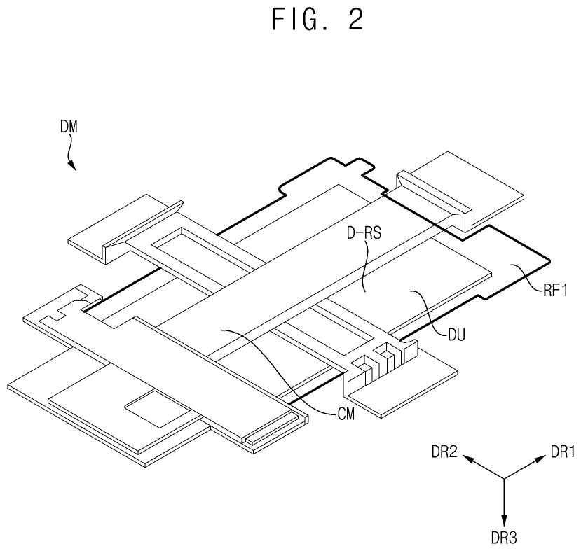

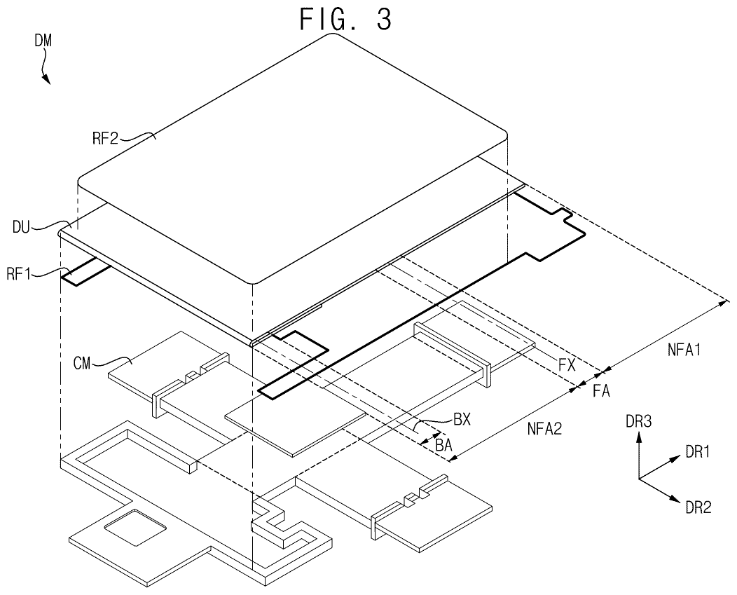

FIG. 1 is a perspective view illustrating a display module according to an embodiment of the present disclosure. FIG. 2 is a perspective view illustrating the display module of FIG. 1 in an upside-down state. FIG. 3 is a exploded perspective view illustrating the display module of FIG. 1 in a disassembled state.

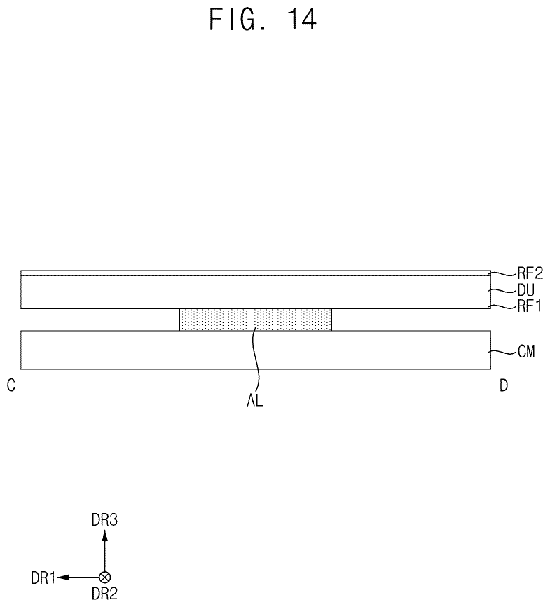

Referring to FIGS. 1, 2, and 3, a display module DM according to an embodiment of the present disclosure may include a display unit DU, a first release film RF1, a second release film RF2, a cover member CM, and an adhesive layer AL (FIG. 14).

In this specification, a plane may be defined by a first direction DR1 and a second direction DR2 which intersects with the first direction DR1. For example, in an embodiment the second direction DR2 may be perpendicular to the first direction DR1. In addition, a third direction DR3 may be perpendicular to the plane. However, embodiments of the present disclosure are not necessarily limited thereto and the first to third directions DR1 to DR3 may intersect each other at various different angles.

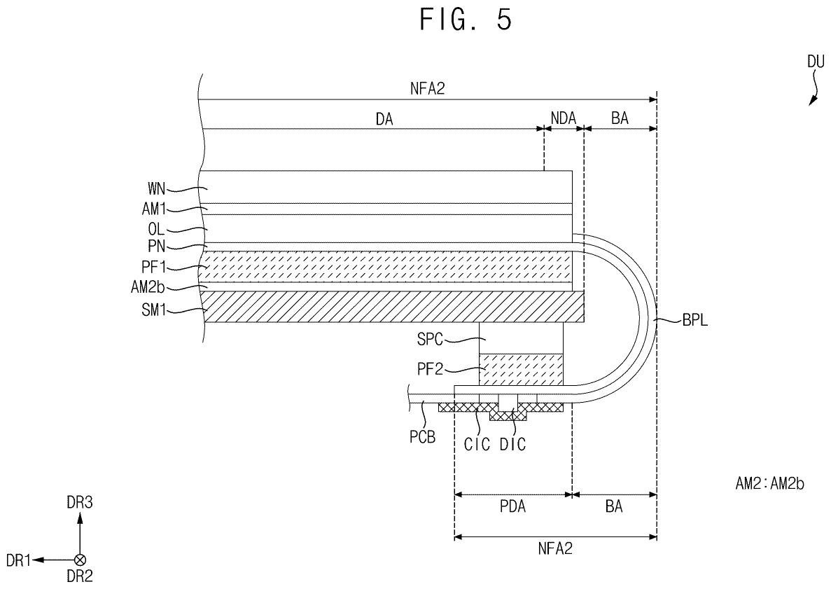

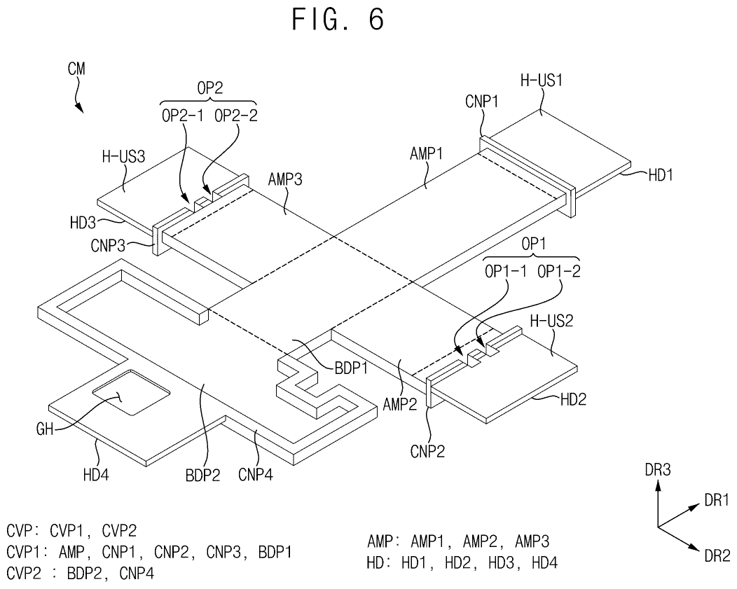

The display unit DP may include a component (e.g., a display panel PN of FIGS. 5 and 6) which emits light. In an embodiment, the display unit DU may include a foldable area FA, a first non-folding area NFA1 and a second non-folding area NFA2 (e.g., arranged in the first direction DR1). The foldable area FA may be an area in which the display unit DU may be folded (e.g., may be flexible or deformable) by an external force. For example, the foldable area FA may include a folding axis FX extending along the second direction DR2.

The first non-folding area NFA1 and the second non-folding area NFA2 may be areas in which at least portions of the display unit DU may not be folded (e.g., may not be flexible or deformable) by the external force. Each of the first non-folding area NFA1 and the second non-folding area NFA2 may be adjacent to the foldable area FA. For example, the first non-folding area NFA1 and the second non-folding area NFA2 may be adjacent to at least one side of the foldable area FA (e.g., in the first direction DR1 or a direction opposite to the first direction DR1). For example, the first non-folding area NFA1 may be adjacent to a first side of the foldable area FA and the second non-folding area NFA2 may be adjacent to an opposite second side of the foldable area FA. In an embodiment, the first non-folding area NFA1 and the second non-folding area NFA2 may be spaced apart from each other in the first direction DR1. The foldable area FA may be located between the first non-folding area NFA1 and the second non-folding area NFA2 (e.g., in the first direction DR1).

In an embodiment, the second non-folding area NFA2 may include a bending area BA and a non-bending area adjacent to at least one side of the bending area BA. A portion of the display unit DU located in the bending area BA may be bent (e.g., is bendable) along the bending axis BX. In an embodiment, the bending axis BX may extend parallel to the second direction DR2. A portion of the display unit DU located in the non-bending area may not be bent and may have a substantially flat surface.

As the display unit DU includes the foldable area FA, the first non-folding area NFA1, and the second non-folding area NFA2, the display module DM may also include the foldable area FA, the first non-folding area NFA1 and the second non-folding area NFA2.

The first release film RF1 may be disposed under the display unit DU (e.g., disposed directly thereunder). For example, the first release film RF1 may be disposed on a rear surface D-US of the display unit DU. In an embodiment, the first release film RF1 is disposed in a direction opposite to the third direction DR3 from the display unit DU and may cover at least a portion of the rear surface D-US of the display unit DU.

A portion of the first release film RF1 may protrude to an outside of the display unit DU in a plan view. Accordingly, after defect inspection of the display unit DU is completed, the first release film RF1 may be easily removed from the display unit DU. In an embodiment, the first release film RF1 may include a transparent material.

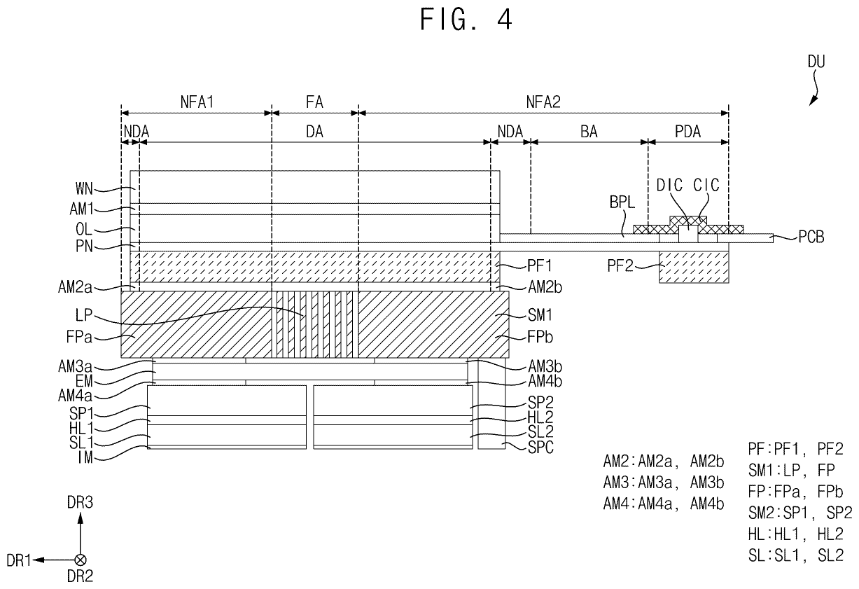

In an embodiment, the first release film RF1 may not cover a portion of the display unit DU that overlaps the bending area BA. For example, the first release film RF1 may not cover a portion of the display unit DU that is bent in a direction opposite to the third direction DR3. In an embodiment, the first release film RF1 includes a driving cover member, a circuit board, and a driver (e.g., a driving cover member CIC, a circuit board PCB, and a driver DIC included in the display unit DU of FIGS. 4 and 5) and the like may not be covered.

The second release film RF2 may be disposed on the display unit DU. For example, the second release film RF2 may be disposed on an upper surface D-US of the display unit DU (e.g., disposed directly thereon in the third direction DR3). The second release film RF2 may cover at least a portion of the upper surface D-US of the display unit DU. The second release film RF2 may protect the upper surface D-US of the display unit DU from external impacts or foreign substances. In addition, in an embodiment, the second release film RF2 may include a transparent material. The cover member CM may be disposed under the first release film RF1 (e.g., in a

direction opposite to the third direction DR3). The cover member CM may cover at least a portion of each of the display unit DU and the first release film RF1. In addition, the cover member CM may cover a portion of the display unit DU that bends along the bending axis BX in the bending area BA. Accordingly, the cover member CM may protect the display unit DU from external impacts or foreign substances. Accordingly, when the display unit DU is transported, defects occurring in the display unit DU may be reduced.

In an embodiment, the cover member CM may include a plastic such as a polycarbonate. In an embodiment, the cover member CM may be manufactured by a plastic molding method such as extrusion or injection molding. However, a material of the cover member CM according to embodiments of the present disclosure is not necessarily limited thereto, and the cover member CM may include a metal or an organic/inorganic composite material.

As shown in FIG. 14, the adhesive layer AL may be disposed between the cover member CM and the first release film RF1 (e.g., in the third direction DR3). For example, the adhesive layer AL may adhere the cover member CM and the first release film RF1 to each other. In an embodiment, the adhesive layer AL may be a double-sided adhesive tape. The adhesive layer AL may be disposed on one side of a first body portion (e.g., a first body portion BDP1 as shown in FIG. 6) of the cover member CM that overlaps the foldable area FA (e.g., in the third direction DR3). However, an arrangement of the adhesive layer AL according to embodiments of the present disclosure is not necessarily limited to this, and may have various arrangements between the cover member CM and the first release film RF1.

FIG. 4 is a cross-sectional view illustrating a cross-section of the display unit of FIG. 1 in an unfolded state. FIG. 5 is a cross-sectional view illustrating a cross-section of the display unit of FIG in a bent state around a bending area.

Referring to FIGS. 4 and 5, in an embodiment the display unit DU may include the display panel PN, an optical functional layer OL, a window layer WN, a first adhesive member AM1, a protective film PF, a first support member SM1, a second adhesive member AM2, a bending protection layer BPL, a spacer SPC, the driver DIC, the driver cover member CIC, the circuit board PCB, a elastic member EM, a third adhesive member AM3, a second support member SM2, a fourth adhesive member AM4, a heat dissipation layer HL, a shock absorption layer SL, and a insulating member IM.

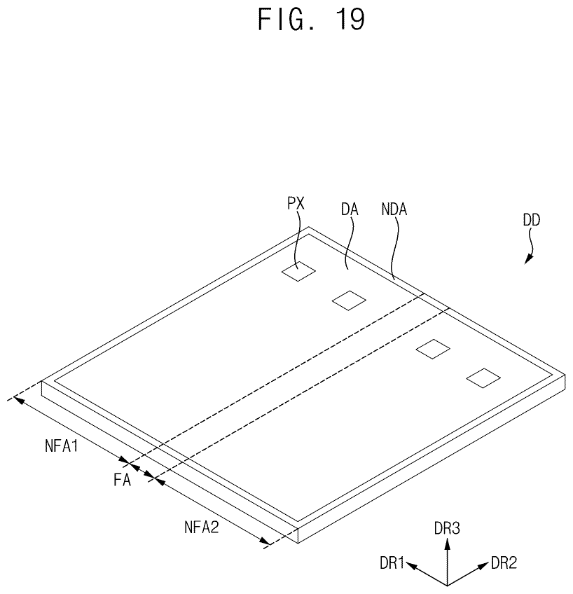

The display panel PN may include a plurality of pixels (e.g., pixels PX of FIG. 19) that generate light. The plurality of pixels may include at least one transistor for generating light, at least one light-emitting layer, and a plurality of metal layers. In an embodiment, the display panel PN may be divided into a display area DA, a non-display area NDA, the bending area BA, and a pad area PDA.

The display area DA may be an area in which the plurality of pixels generate an image by emitting light. The non-display area NDA may be adjacent to the display area DA (e.g., in the first and/or second directions DR1, DR2) and may be an area that does not generate an image. For example, the non-display area NDA may surround at least a portion of the display area DA (e.g., in a plan view). The bending area BA is an area where a portion of the display panel PN is bent along a bending axis (e.g., the bending axis BX of FIG. 3) and may be adjacent to one side of the non-display area NDA. The pad area PDA may be adjacent to the bending area BA and may be spaced apart from one side of the non-display area NDA. Components (e.g., driver DIC, circuit board PCB, and the like) for supplying data signals, driving signals, and the like to the pixels, may be disposed in the pad area PDA.

As described above, the second non-folding area NFA2 may include the bending area BA and the non-bending area. The non-bending area may include a portion of the display area DA, a portion of the non-display area NDA, and the pad area PDA.

The optical functional layer OL may be disposed on the display panel PN (e.g., disposed directly thereon in the third direction DR3). The optical functional layer OL may block external light incident on the display panel PN from the outside (e.g., the external environment). In an embodiment, the optical functional layer OL may be a polarizing layer. The polarizing layer may be stretched in one direction. In an embodiment, the direction in which the polarizing layer is stretched may be an absorption axis that absorbs light, and the direction perpendicular to the calculation direction may be a transmission axis that transmits light. However, the optical functional layer OL according to embodiments of the present disclosure is not necessarily limited to a polarizing layer, and the display unit DU may have a structure that does not include a polarizing layer. In this embodiment, the optical functional layer OL may be a color filter and the like.

The window member WN may be disposed on the optical function layer OL (e.g., in the third direction DR3). The window member WN may protect the display panel PN and the optical functional layer OL. In an embodiment, the window member WN may include a polymer material, a glass thin film, and the like. to enable bending.

In an embodiment, the window member WN may include ultra-thin glass (UTG). For example, the ultra-thin glass may be strengthened and have a predetermined stress profile inside. The ultra-thin glass may further reduce the occurrence of cracks, propagation of cracks, and breakage due to external impacts than before strengthening. The ultra-thin glass may have various stresses in each region through a strengthening process. For example, in an embodiment the ultra-thin glass of the window member WN may be thin film glass that has been chemically strengthened to have increased strength. However, embodiments of the present disclosure are not necessarily limited thereto, and the ultra-thin glass of the window member WN may be thin film glass that has been thermally strengthened.

In an embodiment in which a glass included in the window member WN is composed of an ultra-thin film or a thin film, the window member WN may have flexible characteristics and may have characteristics to be able to be bent, bent, folded, or rolled. For example, in an embodiment the window member WN may include glass such as a soda lime glass, alkali alumino silicate glass, a borosilicate glass, a lithium alumina silicate glass, and the like. These materials may be used alone or in combination with each other. However, embodiments of the present disclosure are not necessarily limited thereto, and the window member WN may include various types of glass.

A protective layer may be further disposed on the window member WN. In an embodiment, the protective layer, together with the window member WN, may perform at least one of functions such as absorbing shock generated from the outside of the display unit DU, preventing scratches, preventing fingerprints, and preventing glare. In an embodiment, the protective layer may include a transparent polymer film.

The first adhesive member AM1 may be disposed between the optical function layer OL and the window member WN (e.g., in the third direction DR3). The first adhesive member AM1 may couple the optical function layer OL and the window member WN to each other. For example, in an embodiment the first adhesive member AM1 may include an optical clear adhesive (OCA), a pressure sensitive adhesive (PSA), a photocurable resin, a thermosetting resin, and the like. These materials may be used alone or in combination with each other.

The protective film PF may be disposed on the lower portion of the display panel PN (e.g., in a direction opposite to the third direction DR3). The protective film PF may include a polymer material. For example, in an embodiment the polymer material includes polyimide (PI), polyethylene terephthalate (PET), polycarbonate (PC), polyethylene (PE), polypropylene (PP), polysulfone (PSF), polymethyl methacrylate (PMMA), triacetyl cellulose (TAC), cycloolefin polymer (COP), and the like. These materials may be used alone or in combination with each other.

In an embodiment, the protective film PF may include a first protective film PF1 overlapping the display area DA and the non-display area NDA, and a second protective film PF2 overlapping the pad area PDA. The first protective film PF1 and the second protective film PF2 may be spaced apart from each other (e.g., in a plan view).

The first support member SM1 may be disposed under the protective film PF (e.g., in a direction opposite to the third direction DR3). The first support member SM1 may serve to support the display panel PN. In addition, the first support member SM1 may serve to assist in folding the display panel PN. In addition, the first support member SM1 may prevent foreign substances from entering the display panel PN from the outside (e.g., the external environment). In addition, the first support member SM1 may radiate or disperse heat generated in the display panel PN. In an embodiment, a rigidity of the first support member SM1 may be greater than a rigidity of the display panel PN. Accordingly, the first support member SM1 may prevent the display panel PN from being deformed due to an external force applied by the user, and the like.

In an embodiment, the first support member SM1 may include a first flat portion FPa, a second flat portion FPb, and a lattice portion LP. The lattice portion LP may be located between the first flat portion FPa and the second flat portion FPb (e.g., in the first direction DR1). The lattice portion LP may overlap the foldable area FA, the first flat portion Fpa may overlap the first non-folding area NFA1, and the second flat portion FPb may overlap the second non-folding area. Accordingly, the first flat portion FPa and the second flat portion FPb may support the portion of the display panel PN that overlaps the first non-folding area NFA1 and the second non-folding area NFA2, and the lattice portion LP may help the display panel PN in a folded configuration.

The lattice portion LP may have elasticity in response to folding and unfolding of the display unit DU. However, although FIG. 4 illustrates only one lattice portion LP, embodiments of the present disclosure are not necessarily limited this. For example, the lattice portion LP may be formed in a plurality of pieces in some embodiments.

In an embodiment, the first support member SM1 may include an alloy. For example, the first support member SM1 may include a stainless steel (SUS), a magnesium alloy, and the like. However, embodiments of the present disclosure are not necessarily limited thereto. For example, in an embodiment, the first support member SM1 may include glass or plastic. For example, the first support member SM1 may include a carbon fiber reinforced plastic (CFRP), a glass fiber reinforced plastic (GFRP), and the like. However, embodiments of the present disclosure are not necessarily limited to this, and the first support member SM1 may include various materials.

The second adhesive member AM2 may be disposed between the protective film PF and the first support member SM1 (e.g., in the third direction DR3). For example, the second adhesive member AM2 may couple the protective film PF and the first support member SM1 to each other. For example, in an embodiment the second adhesive member AM2 may include an optically clear adhesive, a pressure-sensitive adhesive, a photocurable resin, or a thermosetting resin. These materials may be used alone or in combination with each other.

In an embodiment, the second adhesive member AM2 may include a 2-1 adhesive member AM2a and a 2-2 adhesive member AM2b. The 2-1 adhesive member AM2a overlaps the first non-folding area NFA1 and may couple the first flat portion FPa and the protective film PF to each other. The 2-2 adhesive member AM2b overlaps the second non-folding area NFA2 and may couple the second flat portion FPb and the protective film PF to each other.

The bending protection layer BPL may be disposed on one side of the display panel PN. The bending protection layer BPL may be disposed on the one surface of the display panel PN over a portion of the non-display area NDA, the bending area BA, and a portion of the pad area PDA. For example, in an embodiment as shown in FIG. 4 in which the display unit DU is in an unfolded configuration, the bending protection layer BPL may be disposed on one side of the display panel PN facing the third direction DR3. As the display panel PN is bent in the bending area BA, the bending protection layer BPL may also be bent in the bending area BA. Accordingly, the bending protection layer BPL may partially protect the display panel PN from impacts or foreign substances located outside of the bending area BA.

In an embodiment, the bending protection layer BPL may include a photocurable resin or a thermosetting resin. For example, in an embodiment the bending protection layer BPL may include a epoxy resin, an amino resin, a phenol resin, an urea resin, a melamine resin, an unsaturated polyester resin, poly, a polyurethane resin, a polyimide resin, and the like. These materials may be used alone or in combination with each other.

The spacer SPC may be disposed under the first support member SM1 (e.g., in a direction opposite to the third direction DR3). For example, the spacer SPC may be disposed under an edge of the second flat portion FPb. When the display panel PN is bent in the bending area BA, one surface of the second protective film PF2 may directly contact the spacer SPC. Accordingly, the spacer SPC may fix the second protective film PF2 and the circuit board PCB to a lower portion of the first support member SM1. However, although the number of spacers SPC is illustrated as one in FIG. 5, embodiments of the present disclosure are not necessarily limited thereto, and a plurality of spacers SPC may be included in some embodiments.

In an embodiment, the spacer SPC may include an organic insulating material. However, embodiments of the present disclosure are not necessarily limited thereto. For example, in an embodiment, the spacer SPC may include polyethylene terephthalate, polypropylene (PP), polycarbonate (PC), polystyrene (PS), polyethylene (PE), and the like. These materials be used alone or in combination with each other.

The driver DIC may be disposed on the pad area PDA of the display panel PN. The driver DIC may be electrically connected to the pixels. The driver DIC may generate the data signal to drive the pixels. Accordingly, the pixels may emit light based on the data signal.

In an embodiment, the driver DIC may have a chip on plastic (COP) structure or a chip on glass (COG) structure disposed directly on the display panel PN. However, an arrangement structure of the driver DIC according to embodiments of the present disclosure is not necessarily limited thereto, and the driver DIC may have a chip on film (COF) structure that is directly disposed on a flexible film in some embodiments. In this case, the circuit board PCB may be electrically connected to the flexible film.

The driving cover member CIC may be disposed on (e.g., disposed directly thereon) the driver DIC. In an embodiment, the driving cover member CIC may be disposed on a portion of each of the circuit board PCB and the bending protection layer BPL. For example, the driving cover member CIC may cover the driver DIC while directly contacting a portion of each of the circuit board PCB and the bending protection layer BPL. Accordingly, the driving cover member CIC may protect the driver DIC from external shocks or impurities.

In an embodiment, the driving cover member CIC may be a cover tape. For example, the cover tape may include synthetic resin such as a polyethylene terephthalate (PET).

The circuit board PCB may be adjacent to the display panel PN located in the pad area PDA. At least a portion of the circuit board PCB may overlap with at least a portion of the display panel PN located in the pad area PDA. At least a portion of the circuit board PCB may be disposed on one side of the display panel PN. The circuit board CB may supply the driving signal to the display panel PN. In an embodiment, the circuit board PCB may include a timing controller that controls an operation of the display panel PN and a power voltage generator that provides a power supply voltage to the display panel PN.

The circuit board PCB may be fixed to the lower portion of the display panel PN through the spacer SPC and the second protective film PF2. For example, in an embodiment a location of the circuit board PCB may be fixed to be spaced apart from the second flat portion FPb in the third direction DR3 through the spacer SPC and the second protective film PF2.

The elastic member EM may be disposed under the first support member SM1 (e.g., in a direction opposite to the third direction DR3). For example, the elastic member EM may be disposed between the first support member SM1 and the second support member SM2 (e.g., in the third direction DR3). The elastic member EM may partially overlap the foldable area FA. While the display unit DU repeatedly performs folding and unfolding, the elastic member EM may prevent foreign substances from penetrating into the lattice portion LP. In addition, while the display unit DU repeatedly performs folding and unfolding, the elastic member EM may be stretched and contracted so as not to expose the lattice portion LP.

For example, the elastic member EM may include an elastomer having a relatively high elastic force or a relatively high restoring force. For example, in an embodiment the elastic member EM may include an elastic material such as silicone, urethane, thermoplastic polyurethane (TPU), and the like. These materials may be used alone or in combination with each other.

The third adhesive member AM3 may be disposed between the first support member SM1 and the elastic member EM (e.g., in the third direction DR3). The third adhesive member AM3 may couple the first support member SM1 and the elastic member EM to each other. For example, in an embodiment the third adhesive member AM3 may include an optically clear adhesive, a pressure-sensitive adhesive, a photocurable resin, a thermosetting resin, and the like. These materials may be used alone or in combination with each other.

In an embodiment, the third adhesive member AM3 may include a third-first adhesive member AM3a and a third-second adhesive member AM3b. The third-first adhesive member AM3a overlaps the first non-folding area NFA1 and may couple the first flat portion FPa and the elastic member EM to each other. The third-second adhesive member AM3b overlaps the second non-folding area NFA2 and may couple the second flat portion FPb and the elastic member EM to each other.

The second support member SM2 may be disposed under the elastic member EM (e.g., in a direction opposite to the third direction DR3). In an embodiment, the second support member SM2 may include a first support plate SP1 and a second support plate SP2 spaced apart from each other. For example, in an embodiment the first support plate SP1 and the second support plate SP2 may be spaced apart from each other in the first direction DR1. Each of the first support plate SP1 and the second support plate SP2 may at least partially overlap the foldable area FA. For example, when the display unit DU is folded, a distance between the first support plate SP1 and the second support plate SP2 may increase. The second support member SM2 may prevent the lattice portion LP of the first support member SM1 from being pressed.

In an embodiment, the second support member SM2 may include an alloy. For example, in an embodiment the second support member SM2 may include stainless steel (SUS), magnesium alloy, and the like. However, embodiments of the present disclosure are not necessarily limited thereto. For example, in an embodiment, the second support member SM2 may include glass or plastic. For example, the second support member SM2 may include a carbon fiber reinforced plastic (CFRP), a glass fiber reinforced plastic (GFRP), and the like. However, embodiments of the present disclosure are not necessarily limited thereto, and the second support member SM2 may include various materials.

The fourth adhesive member AM4 may be disposed between the second support member SM2 and the elastic member EM (e.g., in the third direction DR3). The fourth adhesive member AM4 may couple the second support member SM2 and the elastic member EM to each other. For example, in an embodiment the fourth adhesive member AM4 may include an optically clear adhesive, a pressure-sensitive adhesive, a photocurable resin, a thermosetting resin, and the like. These materials may be used alone or in combination with each other.

In an embodiment, the fourth adhesive member AM4 may include a fourth-first adhesive member AM4a and a fourth-second adhesive member AM4b. The fourth-first adhesive member AM3a may overlap the first non-folding area NFA1 and couple the elastic member EM to the first support plate SP1. The fourth-second adhesive member AM4b overlaps the second non-folding area NFA2 and may couple the second support plate SP2 and the elastic member EM to each other.

The heat dissipation layer HL may be disposed under the second support member SM2 (e.g., in a direction opposite to the third direction DR3). In an embodiment the heat dissipation layer HL may include a first heat dissipation layer HL1 and a second heat dissipation layer HL2 spaced apart from each other. For example, in an embodiment the first heat dissipation layer HL1 and the second heat dissipation layer HL2 may be spaced apart from each other in the first direction D1. Each of the first heat dissipation layer HL1 and the second heat dissipation layer HL2 may at least partially overlap the foldable area FA.

The heat dissipation layer HL may include a material with a high thermal conductivity. For example, in an embodiment the heat dissipation layer HL may include an aluminum (A1), a copper (Cu), and the like. These materials may be used alone or in combination with each other. However, embodiments of the present disclosure are not necessarily limited thereto. For example, in an embodiment, the heat dissipation layer HL may be omitted.

The shock absorption layer SL may be disposed under the heat dissipation layer HL (e.g., in a direction opposite to the third direction DR3). In an embodiment, the shock absorption layer SL may include a first shock absorption layer SL1 and a second shock absorption layer SL2 spaced apart from each other. For example, in an embodiment the first shock absorption layer SL1 and the second shock absorption layer SL2 may be spaced apart from each other in the first direction D1. Each of the first shock absorption layer SL1 and the second shock absorption layer SL2 may partially overlap the foldable area FA.

The shock absorption layer SL may protect the display panel PN from external shock. In addition, the shock absorption layer SL may include a material having flexibility so that the display device DD may be easily folded. For example, in an embodiment the shock absorption layer SL may include a foam-type material such as polyurethane foam, polystyrene foam, and the like. These materials may be used alone or in combination with each other.

The insulating member IM may be disposed under the shock absorption layer SL (e.g., in a direction opposite to the third direction DR3). For example, the insulating member IM may be in the form of a film or tape. The insulating member IM may prevent rattling from occurring in the display device DD.

As described above, the display unit DU according to embodiments of the present disclosure may be folded or unfolded and each of the window member WN, the optical function layer OL, the display panel PN, and the first support member SM1 may have a flexibility.

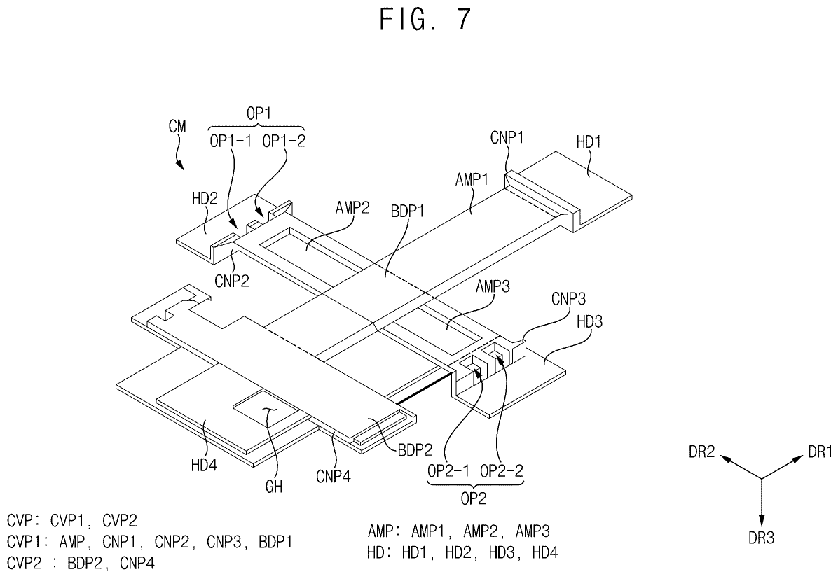

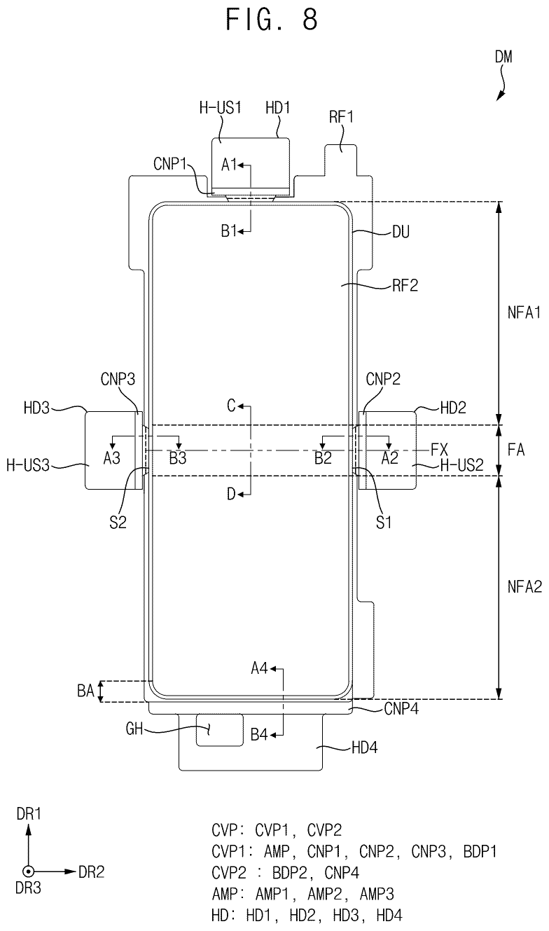

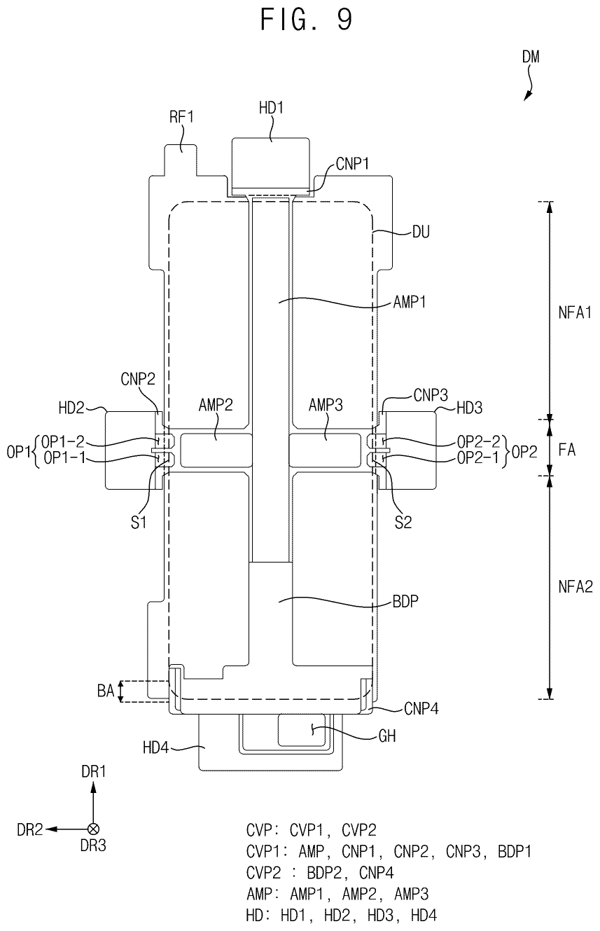

FIG. 6 is a perspective view illustrating the cover member of FIG. 1. FIG. 7 is a perspective view illustrating the cover member of FIG. 1 in an upside-down state. FIG. 8 is a plan view illustrating the display module of FIG. 1. FIG. 9 is a bottom view illustrating the display module of FIG. 1.

Referring to FIGS. 6, 7, 8, and 9, the cover member CM may include a plurality of holding portions HD and a cover portion CVP. In an embodiment, the holding portions HD may include first, second, third, and fourth holding portions HD1, HD2, HD3, and HD4. However, embodiments of the present disclosure are not necessarily limited thereto. In an embodiment, the cover portion CVP may include a first cover portion CVP1 and a second cover portion CVP2 (e.g., adjacent to each other in the first direction DR1). In an embodiment, the first cover portion CVP1 may include an arm portion AMP, first, second, and third connection portion CNP1, CNP2, CNP3, and a body portion BDP1. The second cover portion CVP2 may include a fourth connection portion CNP4 and a second body portion BDP2.

The holding portion HD may function as a handle in the display module DM. For example, the holding portions HD may correspond to a handle by which a user holds the display module DM to transport the display module DM. Accordingly, while the display module DM is being transported, defects generated in the display module DM may be reduced.

The holding portions HD may protrude to the outside of the display unit DU in a plan view. For example, in an embodiment the first holding portion HD1 may protrude from one side of the display unit DU in the first direction DR1 in a plan view. The second holding portion HD2 may protrude from one side of the display unit DU in the second direction DR2 in a plan view. The third holding portion HD3 may protrude from one side of the display unit DU in a direction opposite to the second direction DR2 in a plan view. The fourth holding portion HD4 may protrude from one side of the display unit DU in a direction opposite to the first direction DR1 in a plan view.

In an embodiment, the holding portions HD may be integrated with the cover portion CVP. For example, in an embodiment the first holding portion HD1 may extend directly from the first cover portion CVP1 in the first direction DR1. The second holding portion HD2 may extend directly from the first cover portion CVP1 in the second direction DR2. The third holding portion HD3 may extend directly from the first cover portion CVP1 in a direction opposite to the second direction DR2. The fourth holding portion HD4 may extend from the second cover portion CVP2 in a direction opposite to the first direction DR1. In addition, the fourth holding portion HD4 may be spaced apart from the first body portion BDP1 in a direction opposite to the first direction DR1.

The first, second, third, and fourth holding portions HD1, HD2, HD3, and HD4 may be spaced apart from each other (e.g., in a plan view). For example, the first holding portion HD1 and the fourth holding portion HD4 may be spaced apart from each other in the first direction DR1. The second holding portion HD2 and the third holding portion HD3 may be spaced apart from each other in the second direction DR2. In an embodiment, shapes of the first, second, third holding portions HD1, HD2, and HD3 may be substantially the same as each other in a plan view. However, embodiments of the present disclosure are not necessarily limited thereto. For example, in an embodiment, shapes of at least two of the first, second, third holding portions HD1, HD2, and HD3 may be different from each other in a plan view.

A guide hole GH penetrating the fourth holding portion HD4 in the thickness direction of the fourth holding portion HD4 (e.g., the third direction DR3) may be defined in the fourth holding portion HD4. When the display module DM is coupled to the transfer device, the guide hole GH may serve to fix the display module DM to the transfer device so that the display module DM is not separated from the transfer device. For example, in an embodiment the transfer device may have a protrusion corresponding to the guide hole. However, embodiments of the present disclosure are not necessarily limited thereto.

In an embodiment, the area of the fourth holding portion HD4 (e.g., in a plan view) may be larger than the areas (e.g., in a plan view) of the first, second, and third holding portions HD1, HD2, and HD3. However, the area of the fourth holding portion HD4 according to embodiments of the present disclosure is not necessarily limited thereto, and an area of the fourth holding portion HD4 may be less than or equal to an area of each of the first, second, and third holding portions HD1, HD2, and HD3 in some embodiments.

In an embodiment, the first, second, third, and fourth holding portions HD1, HD2, HD3, and HD4 may be an integral portion of the cover portion CVP that is formed by being bent from the first cover portion CVP1 and the second cover portion CVP2. In an embodiment, each of the upper surfaces H-US1, H-US2, H-US3, H-US4 of the first, second, third, and fourth holding portions HD1, HD2, HD3, HD4 may be located further away in the third direction than a plane that the window member (e.g., the window member WN of FIG. 5) extends in the first direction DR1 and the second direction DR2.

While a number of holding portions HD included in the display module DM is illustrated as four, the number of holding portions HD according to embodiments of the present disclosure is not necessarily limited thereto. For example, in some embodiments a number of holding portions HD may be less than or equal to 3 or greater than or equal to 5.

The cover portion CVP may cover at least a portion of the display unit DU. For example, in an embodiment the first cover portion CVP1 may cover a portion of the display unit DU that overlaps each of the first and second non-folding areas NFA1 and NFA2 and the foldable area NFA. The second cover portion CVP2 may cover a portion of the display unit DU that overlaps only the second non-folding area NFA2. For example, in an embodiment the second body portion BDP2 and the fourth connection portion CNP4 may cover a portion of the display unit DU that overlaps the bending area BA bent along the bending axis BX.

In an embodiment, the first arm portion AMP1 may extend from the first body portion BDP1 in the first direction DR1. The second arm portion AMP2 may extend from the first body portion BDP1 in the second direction DR2. The third arm portion AMP3 may extend from the first body portion BDP1 in a direction opposite to the second direction DR2. In an embodiment, the second arm portion AMP2 and the third arm portion AMP3 may be symmetrical to each other with respect to an imaginary line that passes through the center of the first body portion BDP1 (e.g., in the second direction DR2) and extends parallel to the first direction DR1. However, a shape of the cover member CM according to embodiments of the present disclosure is not necessarily limited to this, and the second arm portion AMP2 and the third arm portion AMP3 may not be symmetrical with respect to the imaginary line in some embodiments. In addition, the second arm portion AMP2 and the third arm portion AMP3 may overlap the foldable area FA of the display unit DU together with the first body portion BDP1.

The first connection portion CNP1 may extend from (e.g., extend directly therefrom) the first arm portion AMP1 along the first direction DR1. The first connection portion CNP1 may connect the first arm portion AMP1 and the first holding portion HD1 to each other. For example, in an embodiment the first connection portion CNP1 may be integrated with the first arm portion AMP1 and the first holding portion HD1. The first connection portion CNP1 may cover a portion of a side surface of the display unit DU adjacent to the first holding portion HD1.

The second connection portion CNP2 may extend from (e.g., extend directly therefrom) the second arm portion AMP2 along the second direction DR2. The second connection portion CNP2 may connect the second arm portion AMP2 and the second holding portion HD2 to each other. For example, in an embodiment the second connection portion CNP2 may be integrated with the second arm portion AMP2 and the second holding portion HD2. The second connection portion CNP2 may partially cover a first side surface S1 of the display unit DU.

In an embodiment, a first opening OP1 exposing at least a portion of the first side surface S1 of the display unit DU may be defined in the second connection portion CNP2. For example, the portion of the first side surface S1 exposed by the first opening OP1 may be at least a portion of the lattice portion (e.g., the lattice portion LP in FIG. 4) of the display unit DU. Accordingly, when looking at the first side surface S1 of the display module DM in a direction opposite to the second direction DR2, defect inspection of the side surface of the lattice portion may be performed easily through the first opening OP1.

In an embodiment, the first opening OP1 may expose a portion of the first release film RF1 directly contacting the rear surface of the display unit DU (e.g., the rear surface D-RS of FIG. 2). For example, the first opening OP1 may expose the rear surface of the lattice portion adjacent to the first side surface S1 of the display unit DU. Accordingly, as described above, since the first release film RF1 includes a transparent material, defect inspection of the rear surface of the lattice portion may be easily performed through the first opening OP1.

In an embodiment, the first opening OP1 may include at least one opening, such as a first-first opening OP1-1 and a first-second opening OP1-2. In an embodiment, the first-first opening OP1-1 and the first-second opening OP1-2 may be spaced apart from each other in the first direction DR1. Each of the first-first opening OP1-1 and the first-second opening OP1-2 may partially expose the first side surface S1 of the display unit DU. However, a number of first openings OP1 according to embodiments of the present disclosure is not necessarily limited to two, and the number of first openings OP1 may be one or three or more in some embodiments. Additionally, in some embodiments the size and shape of at least one of the plurality of first openings OP1 may be different from another of the plurality of first openings OP1.

The third connection portion CNP3 may extend from (e.g., extend directly therefrom) the third arm portion AMP3 in a direction opposite to the second direction DR2. The third connection portion CNP3 may connect the third arm portion AMP3 and the third holding portion HD3 to each other. For example, in an embodiment the third connection portion CNP3 may be integrated with the third arm portion AMP3 and the third holding portion HD3. The third connection portion CNP3 may partially cover a second side surface S2 of the display unit DU.

In an embodiment, a second opening OP2 including at least one opening that exposes at least a portion of the second side surface S2 of the display unit DU may be defined in the third connection portion CNP3. In an embodiment, the portion of the second side surface S2 exposed by the second opening OP2 may be at least a portion of the lattice portion of the display unit DU. Accordingly, when looking at the second side surface S2 of the display module DM in the second direction DR2, defect inspection on the side surface of the lattice portion may be easily performed through the second opening OP2.

In an embodiment, the second opening OP2 may expose a portion of the first release film RF1 directly contacting the rear surface of the display unit DU. For example, in an embodiment the second opening OP2 may expose the rear surface of the lattice portion adjacent to the second side surface S2 of the display unit DU. Accordingly, as described above, since the first release film RF1 includes a transparent material, defect inspection of the rear surface of the lattice portion may be easily performed through the second opening OP2.

In an embodiment, the second opening OP2 may include a second-first opening OP2-1 and a second-second opening OP2-2. The second-first opening OP2-1 and the second-second opening OP2-2 may be spaced apart from each other in the first direction DR1. Each of the second-first opening OP2-1 and the second-second opening OP2-2 may partially expose the second side surface S2 of the display unit DU. However, the number of second openings OP2 according to embodiments of the present disclosure is not necessarily limited to two, and a number of second openings OP2 may be one or three or more in some embodiments. Additionally, in some embodiments the size and shape of at least one of the plurality of second openings OP2 may be different from another of the plurality of second openings OP2.

The second body portion BDP2 may be connected to (e.g., directly connected) the first body portion BDP1. For example, in an embodiment the second body portion BDP2 may be integrated with the first body portion BDP1. The second body portion BDP2 may extend from (e.g., extend directly therefrom) the first body portion BDP1 in a direction opposite to the first direction DR1.

The fourth connection portion CNP4 may extend from (e.g., extend directly therefrom) the second body portion BDP2 in a direction opposite to the first direction DR1. The fourth connection portion CNP4 may connect the second body portion BDP2 and the fourth holding portion HD4 to each other. For example, in an embodiment the fourth connection portion CNP4 may be integrated with the second body portion BDP2 and the fourth holding portion HD4. The fourth connection portion CNP4 may cover at least a portion of the side surface of the display unit DU adjacent to the fourth holding portion HD4.

As described above, the second arm portion AMP2 overlapping the foldable area FA of the display unit DU may be connected to the second holding portion HD2 through the second connection portion CNP2. In addition, the third arm portion AMP3 overlapping the foldable area FA of the display unit DU may be connected to the third holding portion HD3 through the third connection portion CNP3. A first opening OP1 and a second opening OP2 may be defined in the second connection portion CNP2 and the third connection portion CNP3, respectively. As each of the first opening OP1 and the second opening OP2 expose a portion of each of rear and side surfaces of the lattice portion of the display unit DU, an efficiency of defect inspection for the lattice portion of the display module DM may be increased. An embodiment in which both the first opening OP1 and the second opening OP2 are included may have an increased defect inspection as compared to an embodiment in which the first opening OP1 and the second opening OP2 are not included.

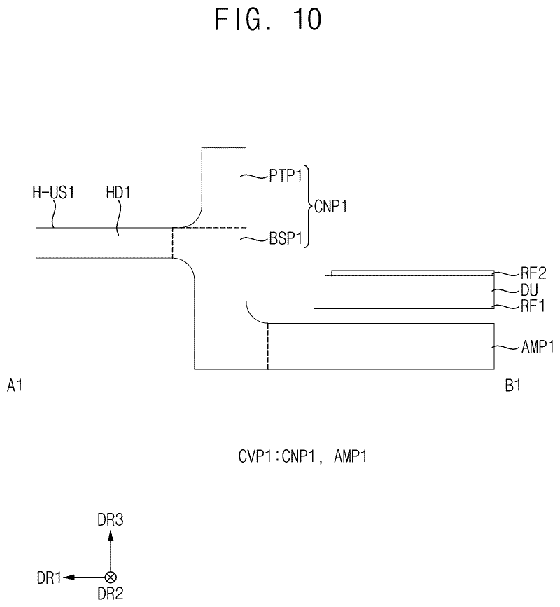

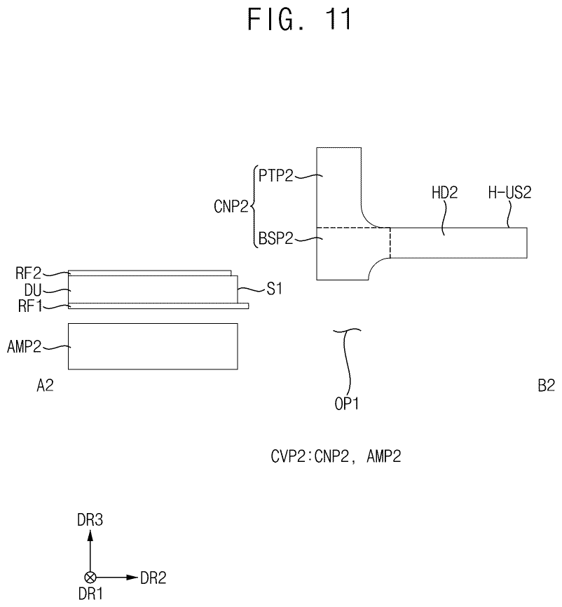

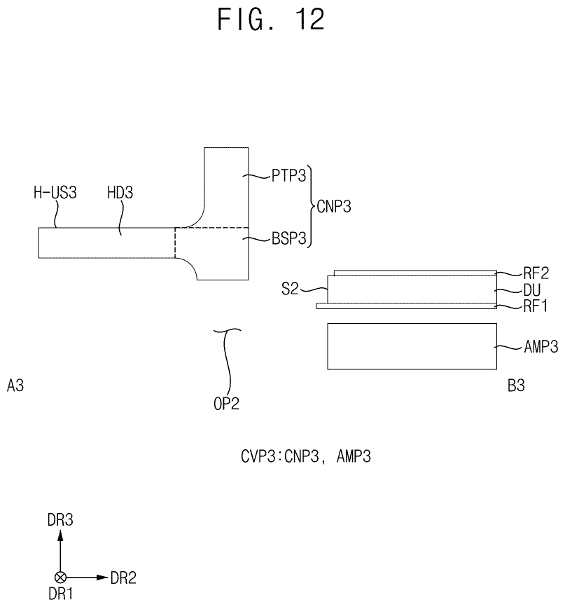

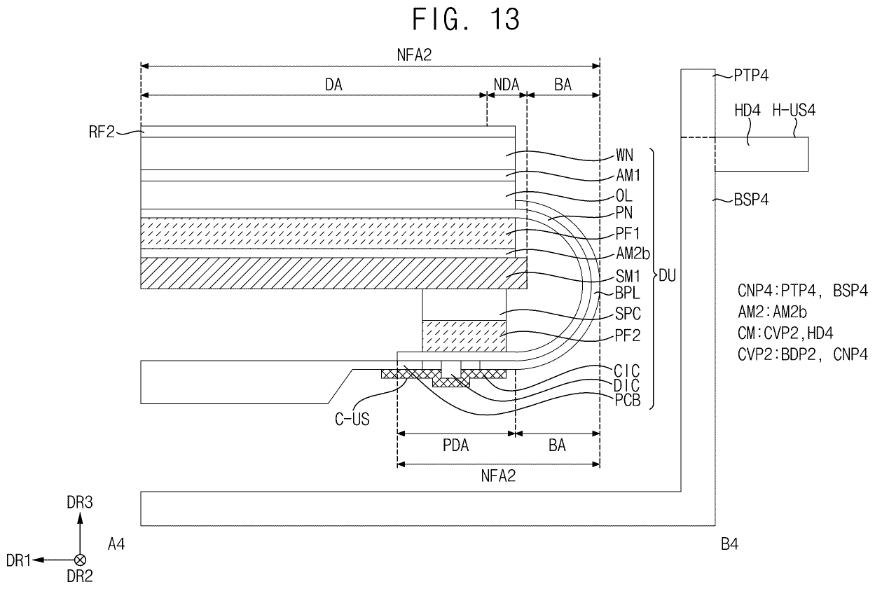

FIG. 10 is a cross-sectional view illustrating a cross-section taken along a line A1-B1 of FIG. 8. FIG. 11 is a cross-sectional view illustrating a cross-section taken along a line A2-B2 of FIG. 8. FIG. 12 is a cross-sectional view illustrating a cross-section taken along a line A3-B3 of FIG. 8. FIG. 13 is a cross-sectional view illustrating a cross-section taken along a line A4-B4 of FIG. 8. FIG. 14 is a cross-sectional view illustrating a cross-section taken along a line C-D of FIG. 8.

Referring to FIGS. 10, 11, 12, 13, and 14, in an embodiment the first connection portion CNP1 may include a first base portion BSP1 and a first protrusion PTP1. In an embodiment, the first base portion BSP1 may be integrated with the first arm portion AMP1 and the first holding portion HD1. The first base portion BSP1 may extend from (e.g., directly extend therefrom) an end of the first arm portion AMP1 to a height at which the upper surface H-US1 of the first holding portion HD1 is located. For example, in an embodiment the upper surface of the first base portion BSP1 and the upper surface H-US1 of the first holding portion HD1 may be co-planar with each other in the third direction DR3. The first base portion BSP1 may cover a portion of the side surface of the display unit DU adjacent to the first holding portion HD1.

In an embodiment, the first protrusion PTP1 may be integrated with the first base portion BSP1. The first protrusion PTP1 may protrude from (e.g., protrude directly therefrom) the first base portion BSP1 in a normal direction of the upper surface H-US1 of the first holding portion HD1. For example, the first protrusion PTP1 may protrude from the first base portion BSP1 in the third direction DR3.

In an embodiment, the second connection portion CNP2 may include a second base portion BSP2 and a second protrusion PTP2. In an embodiment, the second base portion BSP2 may be integrated with the second arm portion AMP2 and the second holding portion HD2. In addition, the second base portion BSP2 may extend from (e.g., extend directly therefrom) an end of the second arm portion AMP2 to a height at which the upper surface H-US2 of the second holding portion HD2 is located. For example, in an embodiment the upper surface of the second base portion BSP2 and the upper surface H-US2 of the second holding portion HD2 may be co-planar with each other in the third direction DR3.

The first opening OP1 may be defined in the second base portion BSP2. The first opening OP1 may expose the first side S1 of the display unit DU. In addition, the first opening OP1 may expose the rear surface of the display unit DU and a portion of the first release film RF1 directly contacting the rear surface.

In an embodiment, the second protrusion PTP2 may be integrated with the second base portion BSP2. The second protrusion PTP2 may protrude from (e.g., protrude directly therefrom) the second base portion BSP2 in a normal direction of the upper surface H-US2 of the second holding portion HD2. For example, in an embodiment the second protrusion PTP2 may protrude from the second base portion BSP2 in the third direction DR3.

In an embodiment, the third connection portion CNP3 may include a third base portion BSP3 and a third protrusion PTP3. In an embodiment, the third base portion BSP3 may be integrated with the third arm portion AMP3 and the third holding portion HD3. In addition, the third base portion BSP3 may extend from (e.g., extend directly therefrom) the end of the third arm portion AMP3 to a height at which the upper surface H-US3 of the third holding portion HD3 is located. For example, in an embodiment the upper surface of the third base portion BSP3 and the upper surface H-US3 of the third holding portion HD3 may be co-planar with each other in the third direction DR3.

The second opening OP2 may be defined in the third base portion BSP3. The second opening OP2 may expose the second side S2 of the display unit DU. In addition, the second opening OP2 may expose the rear surface of the display unit DU and a portion of the first release film RF1 in direct contact with the rear surface.

In an embodiment, the third protruding portion PTP3 may be integrated with the third base portion BSP3. The third protrusion PTP3 may protrude from (e.g., protrude directly therefrom) the third base portion BSP3 in a normal direction of the upper surface H-US3 of the third holding portion HD3. For example, in an embodiment the third protrusion PTP3 may protrude from the third base portion BSP3 in the third direction DR3.

In an embodiment, the fourth connection portion CNP4 may include a fourth base portion BSP4 and a fourth protrusion PTP4. In an embodiment, the fourth base portion BSP4 may be integrated with the second body portion BDP2 and the fourth holding portion HD4. The fourth base portion BSP4 may extend from (e.g., extend directly therefrom) an end of the second body portion BDP2 to a height at which the upper surface H-US4 of the fourth holding portion HD4 is located. For example, in an embodiment the upper surface of the fourth base portion BSP4 and the upper surface H-US4 of the fourth holding portion HD4 may be co-planar with each other in the third direction DR3. The fourth base portion BSP4 may cover a portion of the side surface of the display unit DU adjacent to the fourth holding portion HD4. For example, in an embodiment the fourth base portion BSP4 may cover the bending area BA of the display unit DU together with the second body portion BDP2.

In an embodiment the fourth protruding portion PTP4 may be integrated with the fourth base portion BSP4. The fourth protrusion PTP4 may protrude from (e.g., protrude directly therefrom) the fourth base portion BSP4 in a normal direction of the upper surface H-US4 of the fourth holding portion HD4. For example, in an embodiment the fourth protrusion PTP4 may protrude from the fourth base portion BSP4 in the third direction DR3.

The adhesive layer AL may be disposed in an area where a plane in which the first arm portion AMP1 extends in a direction opposite to the first direction DR1, and a plane in which the second arm portion AMP2 extends in a direction opposite to the second direction DR2 intersect each other. As described above, the adhesive layer AL may couple the cover member CM and the first release film RF1 to each other. Accordingly, the position of the display unit DU can be fixed on the cover member CM during the transport or inspection process of the display module DM.

Below, effects of embodiments of the present disclosure according to Comparative Example and Example according to an embodiment of the present disclosure will be described.

According to the Example according to an embodiment of the present disclosure, a display module DM, which includes first, second, third, and fourth connection portions CNP1, CNP2, CNP3, CNP4, in which first, second, third, and fourth protrusions PTP1, PTP2, PTP3, PTP4 are formed respectively, first, second, third, and fourth holding portions HD1, HD2, HD3, HD4, and a cover member CM formed with a plastic, is manufactured. According to the Comparative Example, first, second, third fourth connection portions CNP1, CNP2, CNP3, CNP4, in which first, second, third, and fourth protrusions PTP1, PTP2, PTP3, PTP4 are not formed, first, second, third, and fourth holding portions HD1, HD2, HD3, HD4, and a cover member formed with a plastic, is manufactured.

Table 1 below evaluates an impact resistance characteristics of display modules including cover members according to the Example and Comparative Example. Specifically, to evaluate the impact resistance characteristics of the display module according to the Example and Comparative Example, by performing a same handling test moving the display module while holding the first, second, third, and fourth holding portions HD1, HD2, HD3, and HD4 in both the Example and Comparative Example a plurality of times, a number of scratches generated on a surface of the display module was measured.

TABLE 1

| | Number of | Number of | |
|---|---|---|---|
| | handling tests | scratches | Defective rate |
| Comparative Example | 121 | 4 | 3.3% |
| Example | 173 | 1 | 0.6% |

As a result, a defective rate of the display module including the cover member according to the Example is reduced compared to a defective rate of the display module including the cover member according to the Comparative Example.

From the result, the display module DM including the cover member CM according to an embodiment of the present disclosure had an excellent impact resistance characteristics. For example, an impact resistance of the display module DM including the first, second, third, and fourth connection portions CNP1, CNP2, CNP3, and CNP4, including the first, second, third, and fourth protrusions PTP1, PTP2, PTP3, and PTP4 respectively, may be increased.

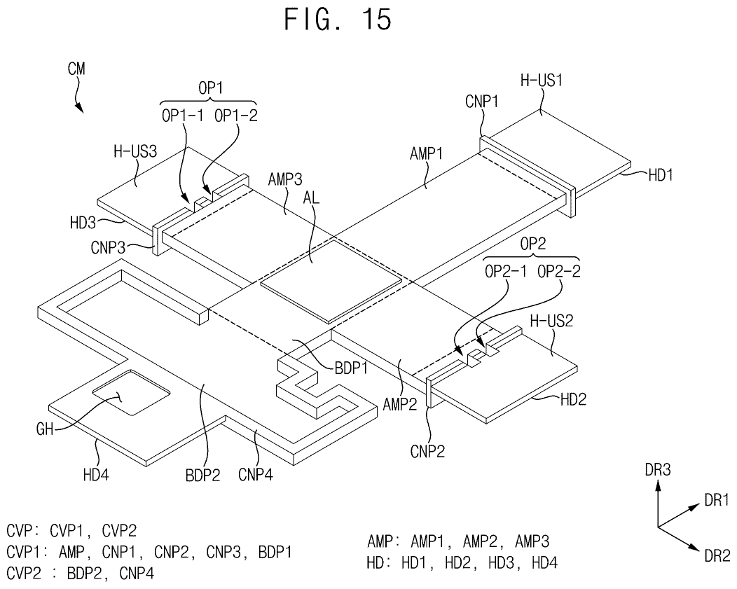

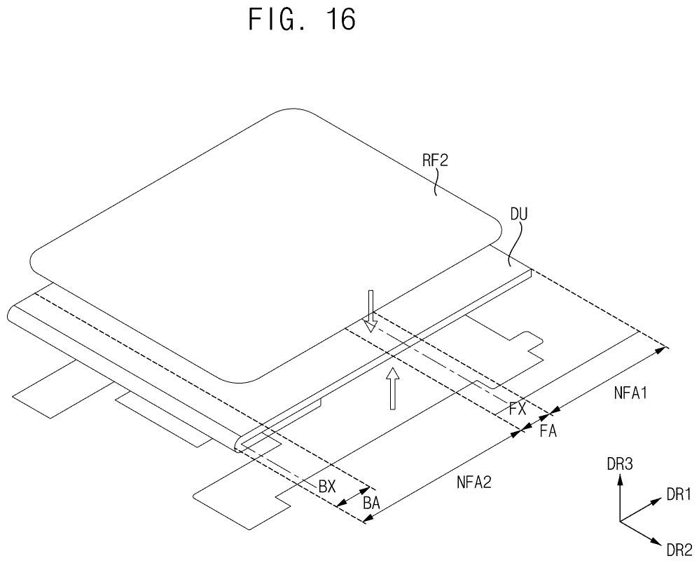

FIGS. 15 and 16 are views illustrating a method of manufacturing the display module of FIG. 1.

Hereinafter, content that overlaps with the content described with reference to FIGS. 1 to 9 may be omitted or simplified for economy of description.

Referring to FIGS. 15 and 16, the adhesive layer AL may be formed on the cover member CM (e.g., formed directly thereon in the third direction DR3). In an embodiment, the adhesive layer AL may be formed on the first body portion BDP1 adjacent to the first, second, third arm portions AMP1, AMP2, and AMP3. In an embodiment, the adhesive layer AL may be a double-sided tape.

Afterwards, the first release film RF1 may be attached on one side (e.g., a first side in the third direction DR3) of the display unit DU. In addition, the second release film RF2 may be attached to the other side (e.g., a second side in the third direction DR3) of the display unit DU opposite to the one side. The first release film RF1 may not be formed on a portion where the display unit DU is bent. For example, in an embodiment the first release film RF1 may not be formed on the circuit board PCB, the driving cover member CIC, and the bending protection layer BPL of FIG. 5 included in the display unit DU. The second release film RF2 may be formed on the window member WN of FIG. 5. However, embodiments of the present disclosure are not necessarily limited thereto. For example, in an embodiment in which the display unit DU further includes a protective layer formed on the window member WN, the second release film RF2 may be formed on the protective layer.

Afterwards, the display unit DU coupled to each of the first release film RF1 and the second release film RF2 may be coupled to the cover member CM. For example, the display unit DU and the cover member CM may be coupled to each other so that the first release film RF1 directly contacts the adhesive layer AL. Accordingly, the display module DM of FIG. 1 may be manufactured.

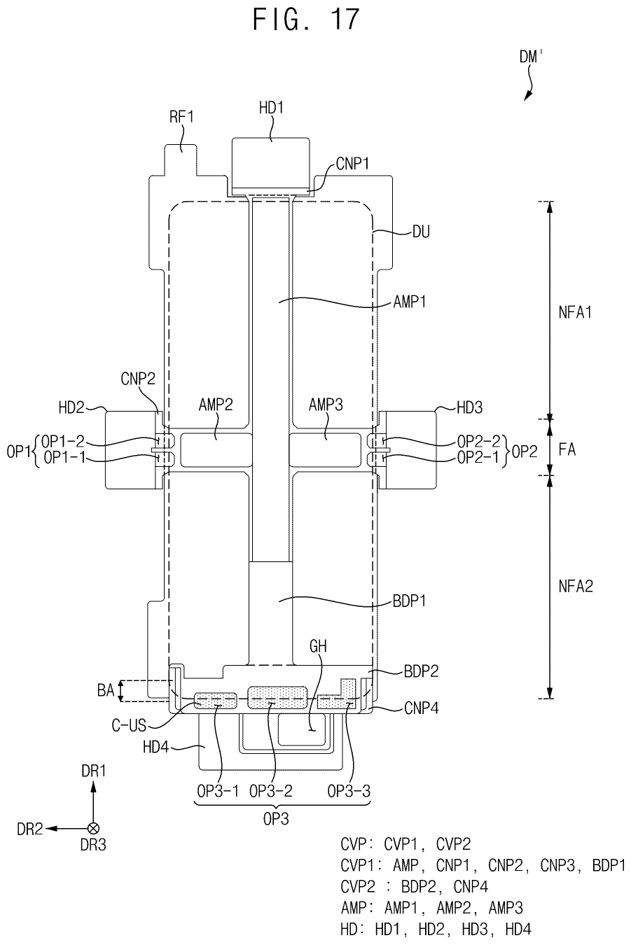

FIG. 17 is a bottom view illustrating a display module according to another embodiment of the present disclosure.

The display module DM′ described with reference to FIG. 17 is substantially a same as the display module DM described with reference to FIGS. 1, 2, 3, 4, 5, 6, 7, 8, and 9 except for the third opening OP3.

Hereinafter, content that overlaps with the content described with reference to FIGS. 1, 2, 3, 4, 5, 6, 7, 8, and 9 will be omitted or simplified.

Referring to FIG. 17, in an embodiment a third opening OP3 may be defined in the second body portion BDP2. The third opening OP3 may include at least one opening that exposes a portion of the driving cover member (e.g., the driving cover member CIC of FIG. 5). For example, in an embodiment the third opening OP3 may expose a portion of the upper surface C-US of the driving cover member. For example, the third opening OP3 may not overlap the first release film RF1 in a plan view. Accordingly, defects generated in the driving cover member (e.g., wrinkles generated in the driving cover member, and the like) may be inspected more easily.

In an embodiment, the third opening OP3 may include a third-first opening OP3-1, a third-second opening OP3-2, and a third-third opening OP3-3. However, embodiments of the present disclosure are not necessarily limited thereto and the number of the openings of the third opening OP3 may vary. The third-first opening OP3-1, the third-second opening OP3-2, and the third-third opening OP3-3 may be spaced apart from each other in the second direction DR2. In an embodiment, shapes of the third-first opening OP3-1, the third-second opening OP3-2, and the third-third opening OP3-3 may be different from each other in a plan view. However, embodiments of the present disclosure are not necessarily limited thereto, and a shape of each of at least two openings among the third-first opening OP3-1, the third-second opening OP3-2, and the third-third opening OP3-3 may be substantially the same as each other in a plan view in some embodiments.

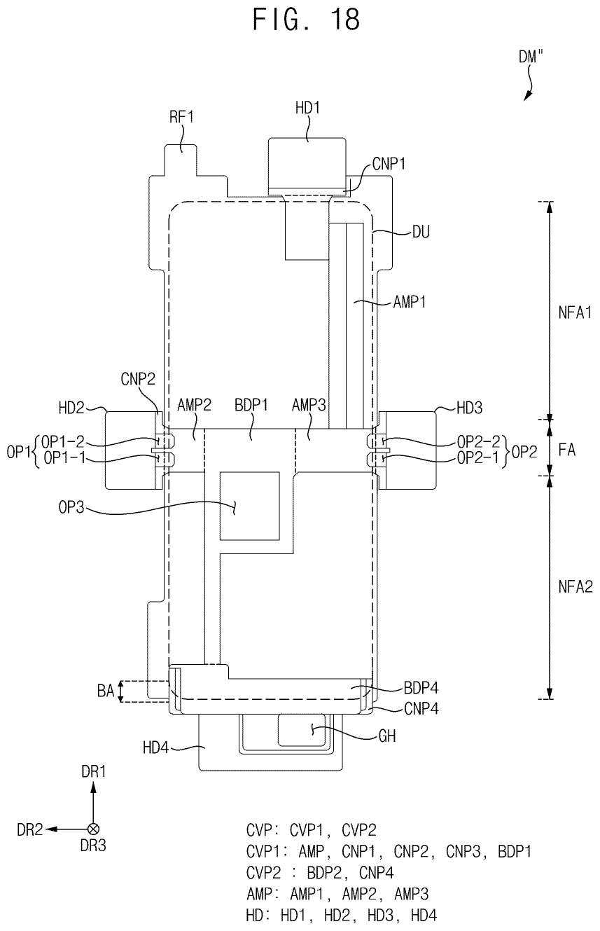

FIG. 18 is a bottom view illustrating a display module according to an embodiment of the present disclosure.

The display module DM″ described with reference to FIG. 17 is substantially a same as the display module DM described with reference to FIGS. 1, 2, 3, 4, 5, 6, 7, 8, and 9, except for the first arm portion AMP1 and the third opening OP3.

Hereinafter, content that overlaps with the content described with reference to FIGS. 1, 2, 3, 4, 5, 6, 7, 8, and 9 may be omitted or simplified for economy of explanation.

Referring to FIG. 18, a third opening OP3 may be defined in the first body portion BDP1. The third opening OP3 may expose a portion of the first release film RF1. For example, as described above, since the first release film RF1 includes a transparent material, the third opening

OP3 may expose a portion of the rear surface of the display unit DU directly contacting the first release film RF1. Accordingly, inspection of a specific location on the rear surface of the display unit DU for defects through the third opening OP3 may be performed easily. The specific location may be a portion of the rear surface of the display unit DU that needs to be inspected and may vary from the location shown in FIG. 18.

As the third opening OP3 is formed in the first body portion BDP1, the first arm portion AMP1 may be disposed closer to the second holding portion HD2 than the third holding portion HD3 so that a location of the first arm portion AMP1 is away from a location of the third opening OP3. However, embodiments of the present disclosure are not necessarily limited thereto, and the first arm portion AMP1 may have various arrangements or shapes.

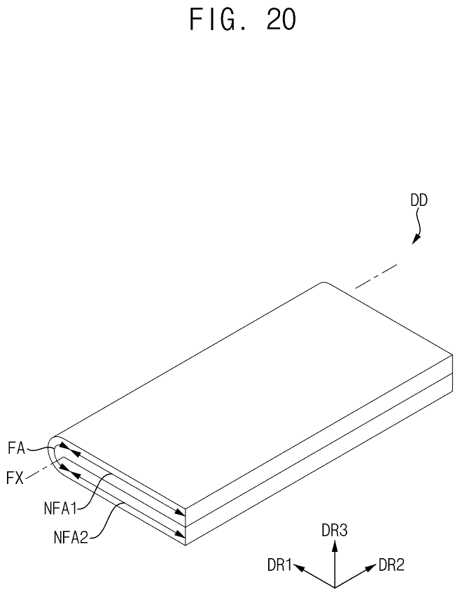

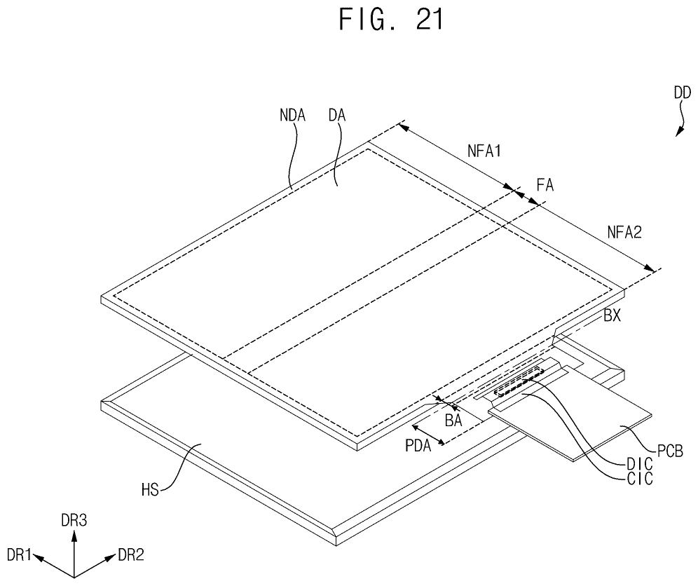

FIG. 19 is a perspective view illustrating a display device manufactured using the display module of FIG. 1. FIG. 20 is a perspective view illustrating the display device of FIG. 19 in a folded state. FIG. 21 is a exploded perspective view illustrating the display device of FIG. 19 in a disassembled state.

Referring to FIGS. 19, 20, and 21, in an embodiment a display device DD may include a display unit DU and a housing HS. As the display unit DU includes the first and second non-folding areas NFA1 and NFA2, and the foldable area FA, the display device DD may also include the first and second non-folding areas NFA1 and NFA2, and a foldable area FA. In addition, as the display unit DU includes the display area DA and the non-display area NDA, the display device DD may also include the display area DA and the non-display area NDA.

A plurality of pixels PX may be arranged in the display area DA. For example, in an embodiment the pixels PX may be arranged in the first direction DR1 and the second direction DR2. The display device DD may be folded along the folding axis FX. In an embodiment, when the display device DD is folded, the display device DD may have an in-folding structure in which the display areas DA face each other. However, embodiments of the present disclosure are not necessarily limited thereto. For example, in an embodiment, when the display device DD is folded, the display device DD may have an out-folding structure in which the display areas DA do not face each other and are disposed outside the display device DD.

The display device DD according to embodiments of the present disclosure is not necessarily limited to having one foldable area FA. For example, the display device DD may be folded multiple times or may have a plurality of foldable areas FA to implement a rollable display device DD.

The housing HS may cover the rear surface of the display unit DU. The housing HS may accommodate and protect a battery module, a camera module, a memory, a video input module, an audio input module, and an external interface module connected to the display unit DU.

In an embodiment, the display device DD may be manufactured by coupling the housing HS to the display unit DU by removing the first and second release films RF1, RF2 and the cover member CM from the display module DM of FIG. 1.

The display module according to embodiments of the present disclosure may be applied to a display device included in a computer, a notebook, a mobile phone, a smartphone, a smart pad, a PMP, a PDA, an MP3 player, or the like. However, embodiments of the present disclosure are not 5 necessarily limited thereto and the display device may be applied to various other small, medium and large sized electronic devices.

Although the display module according to embodiments of the present disclosure have been described with reference to the drawings, the described and illustrated embodiments are examples, and may be modified and changed by a person having ordinary knowledge in the relevant technical field without departing from the technical spirit of the present disclosure.

What is claimed is:

1. A display module comprising:
a display unit including a foldable area and a non-folding area adjacent to the foldable area; and
a cover member disposed on a rear surface of the display unit, the cover member including:
a cover portion covering a portion of the display unit overlapping each of the foldable area and the non-folding area, the cover portion having at least one opening defined therein, the at least one opening exposing at least a portion of a side surface of the display unit;
a first holding portion extending from the cover portion in a first direction, the first holding portion protruding to an outside of the display unit in a plan view;
a second holding portion extending from the cover portion in a second direction that intersects with the first direction, the second holding portion protruding to the outside of the display unit in the plan view; and
a third holding portion spaced apart from the second holding portion in the second direction, the third holding portion protruding to the outside of the display unit in the plan view.

2. The display module of claim 1, wherein the non-folding area includes:
a first non-folding area adjacent to a first side of the foldable area; and
a second non-folding area adjacent to a second side of the foldable area opposite to the first side, the second non-folding area is spaced apart from the first non-folding area in the first direction,
wherein the cover portion includes:
a first cover portion covering a portion of the display unit overlapping each of the first non-folding area, the second non-folding area, and foldable area; and
a second cover portion covering a portion of the display unit overlapping the second non-folding area.

3. The display module of claim 2, wherein the first cover portion includes:
a first body portion connected to the second cover portion;
a first arm portion extending from the first body portion in the first direction;
a second arm portion extending from the first body portion in the second direction;
a third arm portion extending from the first body portion in a direction opposite to the second direction;
a first connection portion connecting the first holding portion and first arm portion to each other;
a second connection portion connecting the second holding portion and the second arm portion to each other; and
a third connection portion connecting the third holding portion and the third arm portion to each other.

4. The display module of claim 3, wherein:
the at least one opening includes a first opening and a second opening;
the first opening is defined in the second connection portion, the first opening exposing a portion of a first side surface of the display unit overlapping the foldable area; and
the second opening is defined in the third connection portion, the second opening exposing a portion of a second surface opposite to the first side surface of the display unit overlapping the foldable area.

5. The display module of claim 3, wherein the first connection portion includes:
a first base portion integrated with the first arm portion and the first holding portion, the first base portion extending from an end of the first arm portion to a height co-planar with an upper surface of the first holding portion; and
a first protrusion protruding from an upper surface of the first base portion in a normal direction of the upper surface of the first holding portion.

6. The display module of claim 3, wherein the second connection portion includes:
a second base portion integrated with the second arm portion and the second holding portion, the second base portion extending from an end of the second arm portion to a height co-planar with an upper surface of the second holding portion; and
a second protrusion protruding from an upper surface of the second base portion in a normal direction of the upper surface of the second holding portion.

7. The display module of claim 3, wherein the third connection portion includes:
a third base portion integrated with the third arm portion and the third holding portion, the third base portion extending from an end of the third arm portion to a height co-planar with an upper surface of the third holding portion; and
a third protrusion protruding from an upper surface of the third base portion in a normal direction of the upper surface of the third holding portion.

8. The display module of claim 3, wherein the cover member includes:
a fourth holding portion spaced apart from the first body portion in a direction opposite to the first direction, the fourth holding portion protruding to the outside of the display unit in the plan view,
wherein the second cover portion includes:
a second body portion connected to the first body portion; and
a fourth connection portion connecting the fourth holding portion and the second body portion to each other.

9. The display module of claim 8, wherein the fourth connection portion includes:
a fourth base portion integrated with the second body portion and the fourth holding portion, the fourth base portion extending from an end of the second body portion to a height co-planar with an upper surface of the fourth holding portion; and
a fourth protrusion protruding from an upper surface of the fourth base portion in a normal direction of the upper surface of the fourth holding portion.

10. The display module of claim 8, wherein:
a guide hole is defined in the fourth holding portion, the guide hole penetrating the fourth holding portion in a thickness direction of the fourth holding portion; and
an area of the fourth holding portion in the plan view is greater than an area of each of the first, second, and third holding portions in the plan view.

11. The display module of claim 3, further comprising:
a release film disposed between the display unit and the cover member; and
an adhesive layer disposed between the release film and the cover member.

12. The display module of claim 11, wherein the display unit includes:
a display panel including at least one pixel;
a driver disposed on the display panel; and
a driver cover member covering the driver.

13. The display module of claim 12, wherein a third opening is defined in the second cover portion, the third opening exposing a portion of an upper surface of the driver cover member,
wherein the third opening does not overlap the release film in the plan view.

14. The display module of claim 11, wherein at least one third opening is defined in the first cover portion, the at least one third opening exposes a portion of the rear surface of the display unit.

15. The display module of claim 11, wherein the at least one opening exposes a portion of the release film directly contacting the rear surface of the display unit overlapping the foldable area.

16. The display module of claim 12, wherein:
the second non-folding area includes a bending area that is bendable along a bending axis extending parallel to the second direction,
wherein the second cover portion covers a portion of the display unit overlapping the bending area.

17. A display module comprising:
a display unit including a foldable area and a non-folding area adjacent to the foldable area; and
cover member disposed on a rear surface of the display unit, the cover member including:
a body portion covering a portion of the display unit overlapping the foldable area and the non-folding area;
an arm portion extending from the body portion in a first direction or a second direction that intersects with the first direction;
at least one holding portion spaced apart from the arm portion, the at least one holding portion protruding to an outside of the display unit in a plan view;
a base portion integrated with the arm portion and the at least one holding portion, the base portion extending from a portion adjacent to the arm portion to a height co-planar with an upper surface of the at least one holding portion; and
a protrusion integrated with the base portion, the protrusion protruding from the base portion in a normal direction of the upper surface of the at least one holding portion.

18. The display module of claim 17, wherein at least one opening is defined in the base portion, the at least one opening exposing a side surface of the display unit overlapping the foldable area.

19. The display module of claim 18, further comprising:
a release film disposed between the display unit and the cover member; and
an adhesive layer disposed between the release film and the cover member,
wherein the at least one opening exposes a portion of the release film directly contacting the rear surface of the display unit overlapping the foldable area.

20. The display module of claim 17, wherein an opening is defined in the body portion, the opening exposing at least a portion of the rear surface of the display unit.
